(19) United States
(12) Patent Application Publication
(10) Pub. No.: US 2010/0124616 A1
(43) Pub. Date: May 20, 2010

(54) METHOD OF FORMING AN ABRADABLE COATING

(75) Inventors: Larry Steven Rosenzweig, Clifton Park, NY (US); Farshad Ghasripoor, Glenville, NY (US); Nuo Sheng, Schenectady, NY (US); Luc Stephane Leblanc, Clifton Park, NY (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/273,854

(22) Filed: Nov. 19, 2008

(51) Int. Cl. B05D 3/02; H05H 1/26; C23C 4/06

(52) U.S. Cl. 427/455; 427/226; 427/372.2; 427/535

(57) ABSTRACT

A method of forming a coating comprises depositing a first coating layer on a surface of a substrate, wherein the coating comprises a ceramic or metal, a lubricant, and a fugitive material. At least a portion of the fugitive material is decomposed, transformed or volatized by heating the first coating layer with a localized heat source.

### FIELD OF THE INVENTION

The invention includes embodiments that relate to a method of forming an abradable porous coating.

### BACKGROUND OF THE INVENTION

Porous metal coatings are useful in gas turbine engines as compressor seals. In operation, the rotating compressor blades are intended to cut a groove into the coating to reduce clearances, thereby improving compressor efficiency and minimizing potential damage to the compressor blade tips. The metal coatings may be formed by depositing a metal and polymer composite on the surface of the compressor. To obtain the required microstructure of the coating, it is necessary to remove a portion or all of the retained polymer in the deposited coating. This removal step is often time consuming and causes damage to surrounding engine components. The normal method of removal is to place the coated parts in an air furnace and heat the coating to a given temperature in order to burn the polymer out of the metal. However, when the coating is applied on the casing of an engine, the engine cannot be placed inside a furnace due to its size. Accordingly, there is a need for new methods of forming porous metal coatings on turbine engines that are efficient and do not damage adjacent engine parts.

### BRIEF SUMMARY OF THE INVENTION

In one embodiment, a method of forming a coating comprises depositing a first coating layer on a surface of a substrate, wherein the coating comprises a ceramic or metal; a lubricant; and a fugitive material. At least a portion of the fugitive material is decomposed, transformed or volatized by heating the first coating layer with a localized heat source.

In another embodiment, a method of forming a coating comprises depositing a first coating layer on a surface of a substrate, wherein the first coating layer comprises a ceramic, a lubricant, and a polymeric fugitive material. At least a portion of the polymeric fugitive material is decomposed, transformed or volatized by heating the first coating layer with a plasma torch.

### BRIEF DESCRIPTION OF THE DRAWINGS

FIG. 1 illustrates the structure of an abradable coating made in accordance with an embodiment of the invention.

FIG. 2 illustrates the structure of an abradable coating made in accordance with an alternative embodiment of the invention.

### DETAILED DESCRIPTION OF THE INVENTION

Disclosed herein is a method of forming an abradable porous coating on a substrate. The coating may be used on a variety of substrates, and is particularly useful on rotating machinery, such as turbine engine components. For example, the substrate may be a gas turbine compressor casing, centrifugal compressor casing, turbine shroud, and/or turbo-charger compressor. In a preferred embodiment, the substrate is a gas turbine compressor and the coating is deposited on a surface defining the inside diameter of the compressor casing.

The coating may comprise a ceramic material such as zirconia, alumina, ceria, yttria, magnesia, calcia, disprosia, titania, or a combination thereof. In a preferred embodiment, the coating comprises yttria stabilized zirconia.

In one embodiment, the coating comprises a metal. Metals which may be present in the coating include aluminum, titanium, copper, zinc, nickel, chromium, iron, cobalt, silicon, tungsten, tantalum, molybdenum, yittrium, or a combination thereof. In a preferred embodiment, the coating comprises cobalt. In one embodiment, the metal is a metal alloy. Examples of suitable metal alloys for use in the coating include CoNiCrAlY, AlSi, NiCrAl, NiCrAlY, NiCrFeAl, NiAl, NiCr, FeCrAlY, or a combination thereof. Preferably, the metal alloy is CoNiCrAlY.

The coating may comprise from about 10 weight percent to about 90 weight percent of the ceramic or metal. In one embodiment, the coating comprises from about 30 weight percent to about 90 weight percent of the ceramic or metal. In another embodiment, the coating comprises from about 70 weight percent to about 90 weight percent of the ceramic or metal.

The coating may also comprise a lubricant including, but not limited to hexagonal boron nitride (hBN), graphite, molybdenum disulphide, calcium fluoride, or a combination thereof. In one embodiment, the lubricant is hexagonal boron nitride.

The lubricant may be present in the coating in an amount between about 0.1 weight percent to about 20 weight percent. In one embodiment, the coating comprises from about 3 weight percent to about 15 weight percent of the lubricant. In another embodiment, the coating comprises from about 3 weight percent to about 10 weight percent of the lubricant.

As previously mentioned, a fugitive material is present in the deposited coating. In one embodiment, the fugitive material comprises a polymer. Examples of suitable polymers that may be present in the fugitive material include polyester, polyimide, or styrene. In a preferred embodiment, the polymer is polyester.

The phrase “fugitive material” as used herein means any material present in the coating that may be decomposed, transformed or volatized to form a porous microstructure in the coating. The term “transform” as used herein means altering the morphology of the fugitive material from its original morphology as deposited within the coating. In its original deposited condition within the coating, the fugitive material may be described as a solid surrounded by a metal or ceramic matrix and essentially filling the majority of space within the matrix. In a transformed state, the formation of large voids within the fugitive material structure occurs leaving either a thin layer of fugitive material surrounded by the metal or ceramic matrix or a “stringy” network of retained fugitive material.

The coating may comprise from about 20 volume percent to about 75 volume percent of the fugitive material. In one embodiment, the coating comprises from about 30 volume percent to about 75 volume percent of the fugitive material. In another embodiment, the coating comprises from about 45 volume percent to about 75 volume percent of the fugitive material.

There are several commercially available abradable coating materials which may be used in the invention. An example of a suitable commercial coating includes SM 2042 available from Sulzer Metco Ltd.

The coating layer may be deposited onto the surface of the substrate by any method known to those skilled in the art including, but not limited to plasma spraying, a combustion process or use of a high velocity oxygen flame. In a preferred embodiment, the coating layer is plasma sprayed onto the substrate surface.

The substrate may include a bondcoat layer disposed on the substrate surface beneath the abradable coating. In one embodiment, the bondcoat comprises aluminum, titanium, copper, zinc, nickel, chromium, iron, cobalt, silicon, tungsten, tantalum, molybdenum, yittrium, or a combination thereof. Examples of suitable metal alloys for use in the bondcoat include CoNiCrAlY, AlSi, NiCrAl, NiCrAlY, NiCrFeAl, NiAl, NiCr, FeCrAlY, or a combination thereof. The bondcoat may be applied to the substrate surface by various techniques including plasma spraying, a combustion process or use of a high velocity oxygen flame.

After the coating is deposited onto the substrate surface, the coating is heated using a localized heat source. The coating is heated to a temperature which is high enough to decompose, transform or volatize all or at least a portion of the fugitive material present in the coating. As a result, a porous microstructure is created in the coating. Suitable localized heat sources which may be used in the invention include a plasma torch, high velocity oxygen fuel flame (HVOF), high velocity air fuel flame (HVAF), or other suitable combustion torch. The localized heat source used to deposit the coating on the substrate, as described above, may also be used to create the porous microstructure in the coating.

In one embodiment the coating is heated to a temperature of at least 450 degrees Celsius. In one embodiment the coating is heated to a temperature between about 450 degrees Celsius and about 1000 degrees Celsius. In one embodiment, the coating is heated to a temperature between about 450 degrees Celsius and about 900 degrees Celsius. In yet another embodiment, the coating is heated to a temperature between about 450 degrees Celsius and about 800 degrees Celsius.

After the porous microstructure is created in the first coating layer, one or more additional coating layers may be deposited on the first coating layer using the coating deposition techniques described hereinabove. After each additional coating layer is deposited, the additional coating layer is heated to a temperature which is high enough to decompose, transform or volatize all or at least a portion of the fugitive material present in the additional coating layer.

Due to the intense heat provided by the localized heat source, the rate of decomposition, transformation, or volatization of the fugitive material in the coating is at least 10 square millimeters per second. In one embodiment, the fugitive material is decomposed, transformed or volatized at a rate of about 100 square millimeters per second. In another embodiment, the fugitive material is decomposed, transformed or volatized at a rate of about 200 square millimeters per second. In another embodiment, the fugitive material is decomposed, transformed or volatized at a rate of about 300 square millimeters per second.

The localized heat source has the ability to target specific areas of the coating, and if desired, only select regions of the coating may be heated with the localized heat source to decompose or volatize the fugitive material. Furthermore, due to the controlled manner in which the coating is heated by the localized heat source, overheating or damage to components adjacent to the substrate is prevented.

The following examples, which are meant to be exemplary, not limiting, illustrate compositions and methods of manufacturing of some of the various embodiments described herein.

### EXAMPLES

### Example 1

A coating comprising CoNiCrAlY, boron nitride and polyester is produced on a Stainless Steel 304 plate using a DC plasma torch. A feedstock powder material comprising 27 wt % cobalt, 26 wt % nickel, 17 wt % chromium, 7 wt % aluminum, 0.5 wt % yttrium, 8.5 wt % boron nitride and 14 wt % polyester powder is injected at a feed rate of about 5 pounds per hour in a 7MB DC plasma torch available from Sulzer Metco Ltd. The torch is run at a current of 400 amperes (A), and a power of 21 kilowatts (kW). The plasma forming gas flow rates are 100 standard cubic feet per hour and 5 standard cubic feet per hour (SCFH) for argon and hydrogen, respectively. The plasma torch is rastered across the stainless steel substrate at 600 millimeters (mm) per second while maintaining a constant spray distance of about 5 inches between the torch nozzle and the substrate. A coating having a thickness of approximately 1.1 mm is obtained by rastering the torch across the substrate 85 times.

The deposited coating is subsequently heated using a 7MB DC plasma torch as a localized heat source that is rastered one time across the substrate at 200 millimeters per second, while maintaining a constant spray distance of about 2 inches between the torch nozzle and coating surface. The plasma torch is run at a current of 680 A with a power of 40 kW. The plasma forming gas flow rates are 100 SCFH for argon, and 15 SCFH for hydrogen.

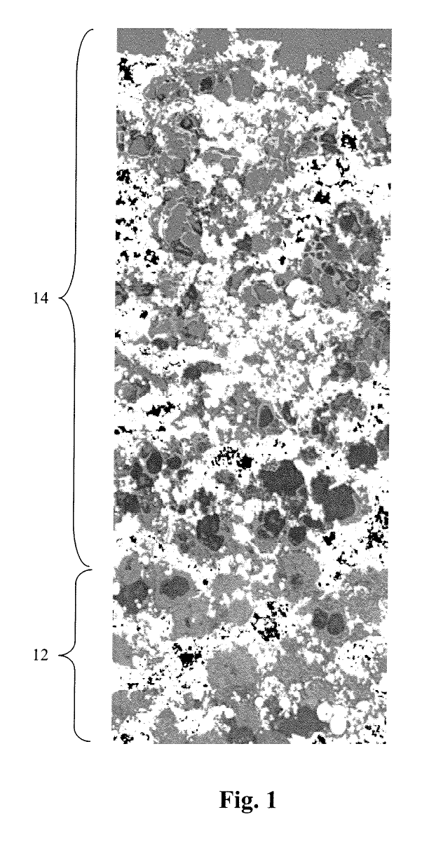

The structure of the resultant coating is illustrated in FIG. 1. The coating comprises CoNiCrAlY and boron nitride with areas of reacted polyester, partially reacted polyester, unreacted polyester and voids. CoNiCrAlY and boron nitride are distributed throughout the entire thickness of the coating. An unreacted polyester region 12 is located near the substrate surface and extends from the substrate surface to have a depth of approximately 27% of the coating thickness. The coating also includes a reacted region 14, which comprises voids and reacted and partially reacted polyester. The reacted region 14 extends from the end of the unreacted region 12 to the coating outer surface, and has a depth of approximately 73% of the coating thickness.

### Example 2

A feedstock powder material comprising 27 wt % cobalt, 26 wt % nickel, 17 wt % chromium, 7 wt % aluminum, 0.5 wt % yttrium, 8.5 wt % boron nitride and 14 wt % polyester powder is injected at a feed rate of about 5 pounds per hour in a 7MB DC plasma torch available from Sulzer Metco Ltd. The torch is run at a current of 400 A, and a power of 21.6 kW. The plasma forming gas flow rates are 125 SCFH and 5 SCFH for argon and hydrogen, respectively. The plasma torch is rastered across a Stainless Steel 304 plate at 600 mm per second while maintaining a constant spray distance of about 4 inches between the torch nozzle and the substrate. A first coating layer having a thickness of approximately 0.36 mm is obtained by rastering the torch across the substrate 21 times.

The first deposited coating layer is subsequently heated using a 7MB DC plasma torch as a localized heat source that is rastered twice across the substrate at 200 mm per second while maintaining a constant spray distance of about 2 inches between the torch nozzle and coating surface. The plasma torch is run at a current of 680 A with a power of 40 kW. The plasma forming gas flow rates are 100 SCFH for argon, and 15 SCFH for hydrogen.

The steps described above for depositing and heating the first coating layer are repeated two more times, wherein the additional coating layers are deposited on top of the first coating layer to form a three-layer coating on the stainless steel substrate. After the additional coating layers are deposited, the coating has a thickness of about 1.1 mm.

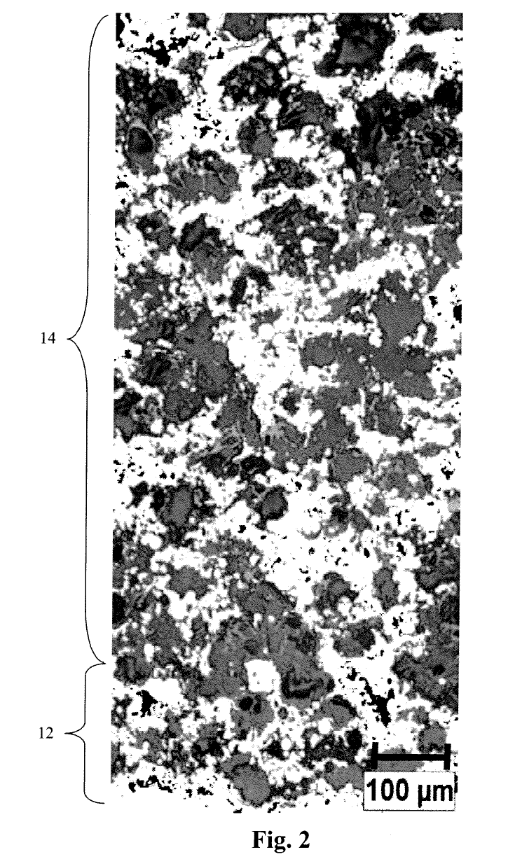

The structure of the resultant coating is illustrated in FIG. 2. The coating comprises CoNiCrAlY and boron nitride with areas of reacted polyester, partially reacted polyester, unreacted polyester and voids. CoNiCrAlY and boron nitride are distributed throughout the entire thickness of the coating. An unreacted polyester region 12 is located near the substrate surface and extends from the substrate surface to have a depth of approximately 15% of the coating thickness. The coating also includes a reacted region 14, which comprises voids and reacted and partially reacted polyester. The reacted region 14 extends from the end of the unreacted region 12 to the coating outer surface, and has a depth of approximately 85% of the coating thickness.

All ranges disclosed herein are inclusive of the endpoints, and the endpoints are combinable with each other. The terms “first,” “second,” and the like as used herein do not denote any order, quantity, or importance, but rather are used to distinguish one element from another. The modifiers “about” and “approximately” used in connection with a quantity are inclusive of the stated value and have the meaning dictated by the context (e.g., includes the degree of error associated with measurement of the particular quantity). The use of the terms “a” and “an” and “the” and similar referents in the context of describing the invention (especially in the context of the following claims) are to be construed to cover both the singular and the plural, unless otherwise indicated herein or clearly contradicted by context.

While the invention has been described in detail in connection with a number of embodiments, the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A method of forming a coating comprising:
depositing a first coating layer on a surface of a substrate, the first coating layer comprising:
a ceramic or metal;
a lubricant; and
a fugitive material; and
decomposing, transforming or volatizing at least a portion of the fugitive material by heating the first coating layer with a localized heat source.

2. The method of claim 1, wherein decomposing, transforming or volatizing at least a portion of the fugitive material creates a porous microstructure in the coating.

3. The method of claim 1, wherein the fugitive material comprises a polymer.

4. The method of claim 3, wherein the fugitive material comprises a polyester, polyimide, styrene, or a combination thereof.

5. The method of claim 1, wherein heating the first coating layer with a localized heat source comprises:
heating the first coating layer with a plasma torch, a high velocity oxygen fuel flame, or a high velocity air fuel flame.

6. The method of claim 5, wherein heating the first coating layer with a localized heat source comprises:
heating the first coating layer with a plasma torch.

7. The method of claim 1, wherein the coating is heated to a temperature of at least 450 degrees Celsius.

8. The method of claim 1, wherein the coating comprises a metal, and the metal comprises aluminum, titanium, copper, zinc, nickel, chromium, iron, cobalt, silicon, tungsten, tantalum, molybdenum, yittrium, or a combination thereof.

9. The method of claim 1, wherein the coating comprises a metal alloy, and the meal alloy comprises CoNiCrAlY, AlSi, NiCrAl, NiCrAlY, NiCrFeAl, NiAl, NiCr, FeCrAlY, or a combination thereof.

10. The method of claim 1, wherein the coating comprises a ceramic, and the ceramic comprises zirconia, alumina, ceria, yttria, magnesia, calcia, disprosia, titania, or a combination thereof.

11. The method of claim 1, wherein the lubricant comprises hexagonal boron nitride (hBN), graphite, molybdenum disulphide, calcium fluoride, or a combination thereof.

12. The method of claim 1, wherein the coating is deposited by plasma spraying, a combustion process or a high velocity oxygen flame.

13. The method of claim 1, wherein the substrate is a machinery component.

14. The method of claim 13, wherein the substrate is a gas turbine compressor.

15. The method of claim 14, wherein the coating is deposited on an inside diameter of a compressor casing.

16. The method of claim 1, wherein the first coating layer comprises between about 20 volume percent and about 75 volume percent of the fugitive material.

17. The method of claim 1, wherein at least a portion of the polymer is decomposed, transformed or volatized at a rate of at least 10 square millimeters per second.

18. The method of claim 1, wherein only a select region of the coating is heated by the plasma torch.

19. The method of claim 1, further comprising:
depositing a second coating layer on a surface of the first coating layer, the second coating layer comprising:
a ceramic or metal;
a lubricant; and
a fugitive material; and
decomposing, transforming or volatizing at least a portion of the fugitive material by heating the second coating layer with a localized heat source.

20. A method of forming a coating comprising:
depositing a first coating layer on a surface of a substrate, the first coating layer comprising:
a ceramic;
a lubricant; and
a polymeric fugitive material; and
decomposing, transforming or volatizing at least a portion of the polymeric fugitive material by heating the first coating layer with a plasma torch.
